(19) United States
(12) Patent Application Publication
(10) Pub. No.: US 2026/0362246 A1
(43) Pub. Date: Nov. 12, 2026

(54) EARLY FULL DUPLEX PREPARATION FOR HANDOVER

(71) Applicant: QUALCOMM Incorporated, San Diego, CA (US)

(72) Inventors: Yan ZHOU, San Diego, CA (US); Kiran VENUGOPAL, Green Brook, NJ (US); Qian ZHANG, Basking Ridge, NJ (US); Jing JIANG, San Diego, CA (US); Junyi LI, Greentown, PA (US)

(21) Appl. No.: 19/205,827

(22) Filed: May 12, 2025

(51) Int. Cl. H04W 36/00; H04L 5/16; H04W 36/08

(52) U.S. Cl. CPC H04W 36/0058; H04L 5/16; H04W 36/0072; H04W 36/08

(57) ABSTRACT

Various aspects of the present disclosure generally relate to wireless communication. In some aspects, a user equipment (UE) may receive, prior to handover or after handover but before transmission of a channel state information (CSI) report, cell parameters for both half-duplex (HD) and full-duplex (FD) symbol types for use in one or more candidate cells. The UE may transmit the CSI report for each of the HD and FD symbol types based on the cell parameters. Numerous other aspects are described.

### FIELD OF THE DISCLOSURE

Aspects of the present disclosure generally relate to wireless communication and specifically relate to techniques, apparatuses, and methods associated with preparing for handover.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving, before transmission of a channel state information (CSI) report, cell parameters for both half-duplex (HD) and full-duplex (FD) symbol types for use in one or more candidate cells. The method may include transmitting the CSI report for each of the HD and FD symbol types based on the cell parameters.

Some aspects described herein relate to a method of wireless communication performed by a UE. The method may include receiving an early transmission configuration indicator (TCI) activation message for a candidate cell that indicates applicable HD and FD symbol types. The method may include communicating a message on a beam associated with the early TCI activation message using an applicable symbol type.

Some aspects described herein relate to a method of wireless communication performed by a network entity. The method may include transmitting, before reception of a CSI report, cell parameters for both HD and FD symbol types for use in one or more candidate cells to a UE. The method may include receiving the CSI report for each of the HD and FD symbol types based at least in part on the cell parameters.

Some aspects described herein relate to an apparatus for wireless communication at a UE. The apparatus may include one or more memories and one or more processors coupled to the one or more memories. The one or more processors may be configured to receive, before transmission of a CSI report, cell parameters for both HD and FD symbol types for use in one or more candidate cells. The one or more processors may be configured to transmit the CSI report for each of the HD and FD symbol types based on the cell parameters.

Some aspects described herein relate to an apparatus for wireless communication at a UE. The apparatus may include one or more memories and one or more processors coupled to the one or more memories. The one or more processors may be configured to receive an early TCI activation message for a candidate cell that indicates applicable HD and FD symbol types. The one or more processors may be configured to communicate a message on a beam associated with the early TCI activation message using an applicable symbol type.

Some aspects described herein relate to an apparatus for wireless communication at a network entity. The apparatus may include one or more memories and one or more processors coupled to the one or more memories. The one or more processors may be configured to transmit, before reception of a CSI report, cell parameters for both HD and FD symbol types for use in one or more candidate cells to a UE. The one or more processors may be configured to receive the CSI report for each of the HD and FD symbol types based at least in part on the cell parameters.

Some aspects described herein relate to a non-transitory computer-readable medium that stores a set of instructions for wireless communication by a UE. The set of instructions, when executed by one or more processors of the UE, may cause the UE to receive, prior to handover or after handover but before transmission of a CSI report, cell parameters for both HD and FD symbol types for use in one or more candidate cells. The set of instructions, when executed by one or more processors of the UE, may cause the UE to transmit the CSI report for each of the HD and FD symbol types based on the cell parameters.

Some aspects described herein relate to a non-transitory computer-readable medium that stores a set of instructions for wireless communication by a UE. The set of instructions, when executed by one or more processors of the UE, may cause the UE to receive an early TCI activation message for a candidate cell that indicates applicable HD and FD symbol types. The set of instructions, when executed by one or more processors of the UE, may cause the UE to communicate a message on a beam associated with the early TCI activation message using an applicable symbol type.

Some aspects described herein relate to a non-transitory computer-readable medium that stores a set of instructions for wireless communication by a network entity. The set of instructions, when executed by one or more processors of the network entity, may cause the network entity to transmit, prior to handover or after handover but before reception of a CSI report, cell parameters for both HD and FD symbol types for use in one or more candidate cells to a UE. The set of instructions, when executed by one or more processors of the network entity, may cause the network entity to receive the CSI report for each of the HD and FD symbol types based at least in part on the cell parameters.

Some aspects described herein relate to an apparatus for wireless communication. The apparatus may include means for receiving, prior to handover or after handover but before transmission of a CSI report, cell parameters for both HD and FD symbol types for use in one or more candidate cells. The apparatus may include means for transmitting the CSI report for each of the HD and FD symbol types based on the cell parameters.

Some aspects described herein relate to an apparatus for wireless communication. The apparatus may include means for receiving an early TCI activation message for a candidate cell that indicates applicable HD and FD symbol types. The apparatus may include means for communicating a message on a beam associated with the early TCI activation message using an applicable symbol type.

Some aspects described herein relate to an apparatus for wireless communication. The apparatus may include means for transmitting, prior to handover or after handover but before reception of a CSI report, cell parameters for both HD and FD symbol types for use in one or more candidate cells to a UE. The apparatus may include means for receiving the CSI report for each of the HD and FD symbol types based at least in part on the cell parameters.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings and appendix. Details of one or more implementations of the subject matter described in this disclosure are set forth in the accompanying drawings, appendix, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of subband full-duplex (SBFD).

FIG. 3 is a diagram illustrating an example of a Layer 1/Layer 2 (L1/L2) triggered mobility (LTM) procedure.

FIG. 4 is a diagram illustrating an example of symbol patterns.

FIG. 5 is a diagram illustrating an example associated with early preparation for handover for half-duplex (HD) and full-duplex (FD) symbol types.

FIG. 6 is a diagram illustrating examples of early transmission configuration indicator (TCI) activation for symbol types.

FIG. 7 is a diagram illustrating an example of a cell switch command for symbol types.

FIG. 8 is a diagram illustrating an example of preparing an FD UE.

FIG. 9 is a diagram illustrating an example process performed, for example, at a UE or an apparatus of a UE.

FIG. 10 is a diagram illustrating an example process performed, for example, at a UE or an apparatus of a UE.

FIG. 11 is a diagram illustrating an example process performed, for example, at a network entity or an apparatus of a network entity.

FIG. 12 is a diagram of an example apparatus for wireless communication.

FIG. 13 is a diagram of an example apparatus for wireless communication.

### DETAILED DESCRIPTION

In wireless communication systems, handover procedures maintain seamless connectivity as a user equipment (UE) moves between different cells. Handover involves transferring an ongoing call or data session from one cell to another. Efficient handover mechanisms ensure minimal disruption and maintain high service quality. The UE may prepare for handover by performing measurements and obtaining configuration information from potential target cells before the actual handover occurs.

A UE may use different symbol types for communication. Full-duplex (FD) operation involves simultaneous transmission and reception that occur on the same frequency band, which can substantially increase spectral efficiency. Subband full duplex (SBFD) is a specific type of FD where downlink and uplink transmissions occur on non-overlapping sub-bands within the same frequency band. This requires separate antenna panels for downlink and uplink to minimize interference. However, SBFD introduces challenges related to different antenna configurations, interference management, and the need for separate configuration parameters for half-duplex (HD) and FD symbols.

Early candidate cell preparation mechanisms are limited to a single duplex mode, either time-division duplex (TDD) or frequency-division duplex (FDD). This limitation affects the UE's ability to immediately operate in both HD and FD symbol types after handover, potentially impacting throughput, latency, and coverage. There is a lack of mechanisms to support early preparation for multiple duplex modes, including HD and FD, which can lead to operational inefficiencies and increased service disruption during handover.

Various aspects relate generally to supporting early candidate cell preparation for multiple duplex modes, including HD and FD symbol types in wireless communication systems. Some aspects more specifically relate to configuring and using cell parameters for both HD and FD symbol types early in the handover process. In some aspects, a UE may receive, prior to handover or after handover but before transmitting a channel state information (CSI) report, cell parameters indicating configurations for HD and FD symbol types. These parameters may include TDD slot format configurations, downlink and uplink frequency resources, uplink synchronization configurations, measurement resources, and reporting configurations for each candidate cell.

In some aspects, the UE may receive an early transmission configuration indicator (TCI) activation message before handover, which specifies the applicable symbol types (HD or FD) and the associated operation parameters. The UE may then communicate messages using these parameters, allowing for optimized beam configurations and efficient transitions between duplex modes. Additionally, the network may configure the UE to perform self-interference (SI)-related measurements to verify the feasibility of FD operation for a candidate cell prior to handover, ensuring that appropriate operation parameters are used post-handover. The UE may perform the SI-related measurements autonomously, or without explicit instruction by a network entity. The UE may determine to perform the SI-related measurements.

Particular aspects of the subject matter described in this disclosure can be implemented to realize one or more of the following potential advantages. By receiving cell parameters for HD and FD symbol types prior to handover, the UE can perform early preparation for multiple duplex modes, allowing for seamless transitions and minimizing service disruptions. This enhances throughput, reduces latency, and provides better coverage by enabling the UE to operate immediately in both HD and FD symbol types after handover.

Furthermore, by configuring separate resources and operation parameters for HD and FD symbol types, a network entity can ensure that the UE is optimally prepared for the target cell's duplex mode. Early TCI activation messages and self-interference measurements further enhance the UE's ability to adapt to the target cell's duplex mode, improving overall communication performance and reliability. Autonomously performing self-interference measurements and transmitting preferred duplex modes and operation parameters can also reduce the network's signaling overhead. As a result, network resources, processing resources, and/or memory resources are conserved, leading to more efficient resource utilization.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

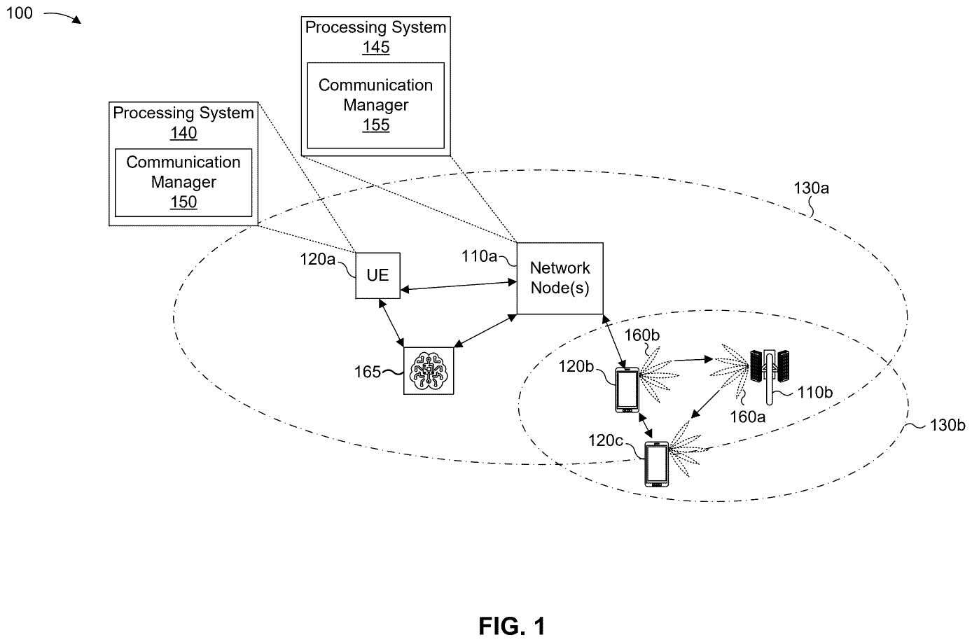

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a TCI state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. As described in more detail elsewhere herein, the communication manager 150 may receive, before transmission of a CSI report, cell parameters for both HD and FD symbol types for use in one or more candidate cells; and transmit the CSI report for each of the HD and FD symbol types based on the cell parameters.

In some aspects, the communication manager 150 may receive an early TCI activation message for a candidate cell that indicates applicable HD and FD symbol types; and communicate a message on a beam associated with the early TCI activation message using an applicable symbol type. Additionally, or alternatively, the communication manager 150 may perform one or more other operations described herein.

In some aspects, a network entity (e.g., network node 110) may include a communication manager 155. As described in more detail elsewhere herein, the communication manager 155 may transmit, prior to handover or after handover but before reception of a CSI report, cell parameters for both HD and FD symbol types for use in one or more candidate cells to a UE; and receive the CSI report for each of the HD and FD symbol types based at least in part on the cell parameters. Additionally, or alternatively, the communication manager 155 may perform one or more other operations described herein.

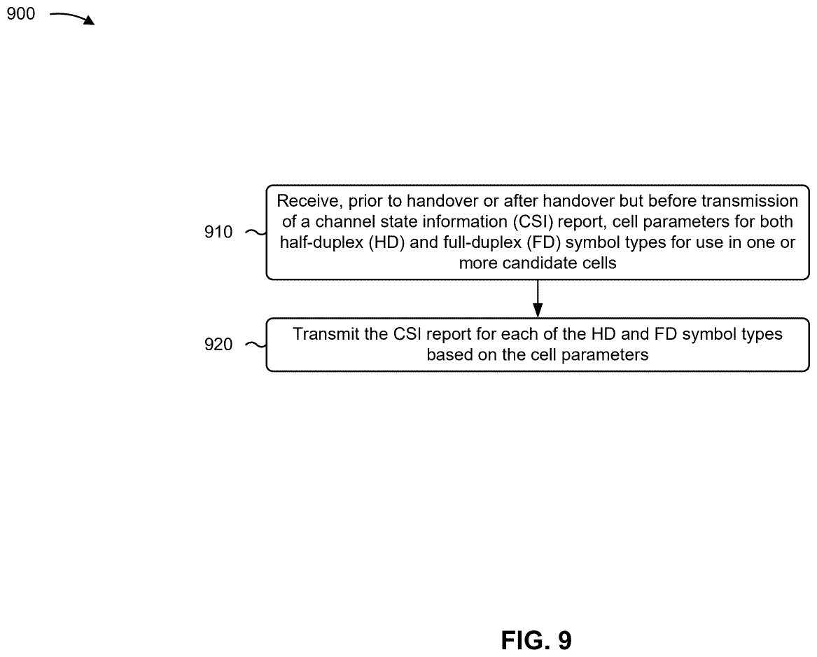

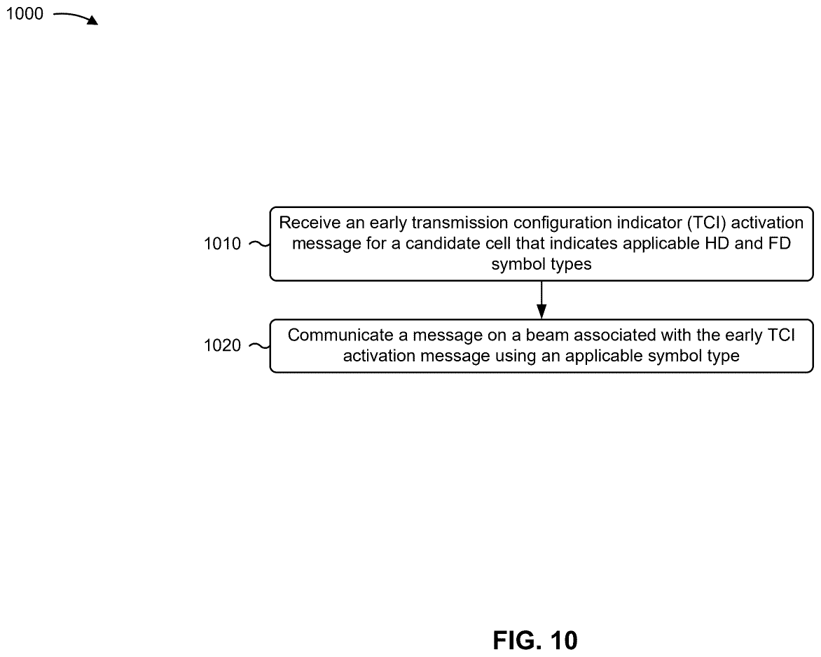

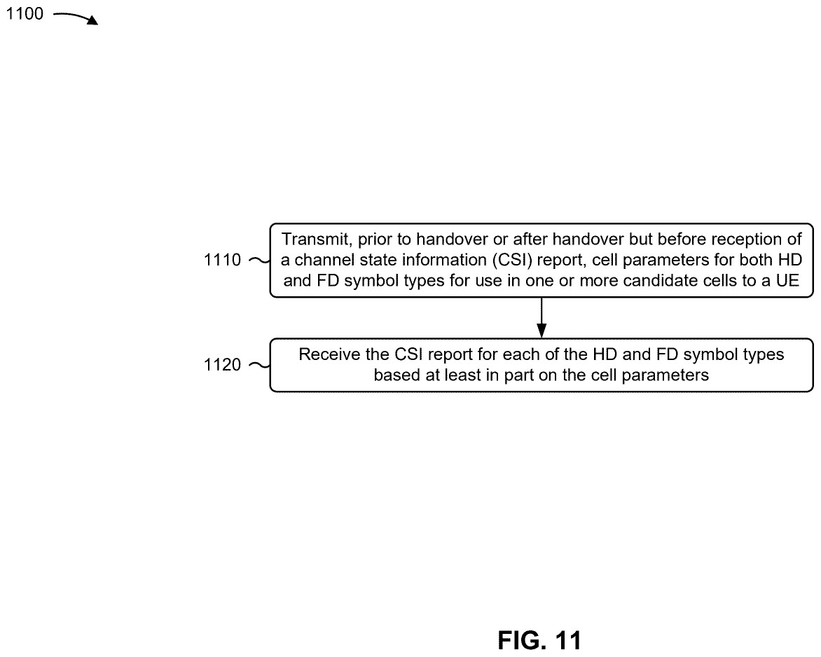

The network node 110, the processing system 145 of the network node 110, the UE 120, the processing system 140 of the UE 120, or any other component(s) of FIG. 1 may implement one or more techniques or perform one or more operations associated with early preparation for HD and FD symbol types for handover, as described in more detail elsewhere herein. For example, the processing system 145 of the network node 110, or the processing system 140 of the UE 120 may perform or direct operations of, for example, process 900 of FIG. 9, process 1000 of FIG. 10, process 1100 of FIG. 11, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 900 of FIG. 9, process 1000 of FIG. 10, process 1100 of FIG. 11, or other processes as described herein. In some examples, executing instructions may include running the instructions, converting the instructions, compiling the instructions, or interpreting the instructions, among other examples.

In some aspects, a UE (e.g., a UE 120) includes means for receiving, before transmission of a CSI report, cell parameters for both HD and FD symbol types for use in one or more candidate cells; or means for transmitting the CSI report for each of the HD and FD symbol types based on the cell parameters.

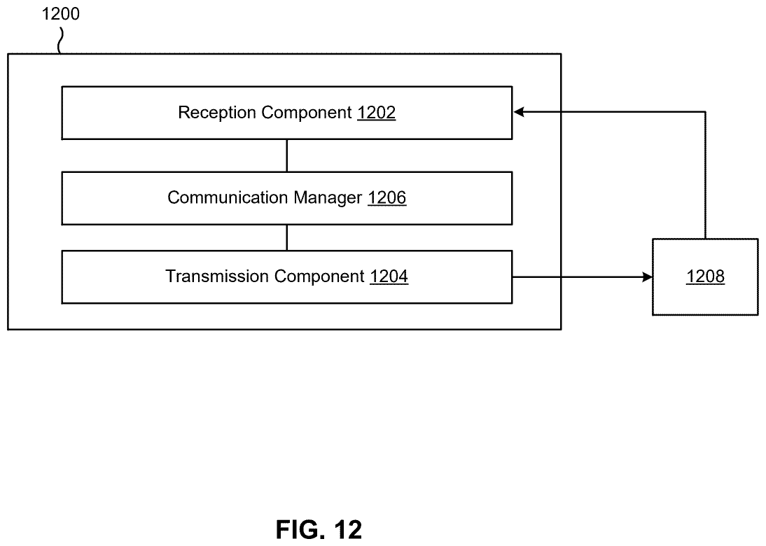

In some aspects, the UE includes means for receiving an early TCI activation message for a candidate cell that indicates applicable HD and FD symbol types; or means for communicating a message on a beam associated with the early TCI activation message using an applicable symbol type. The means for the UE to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

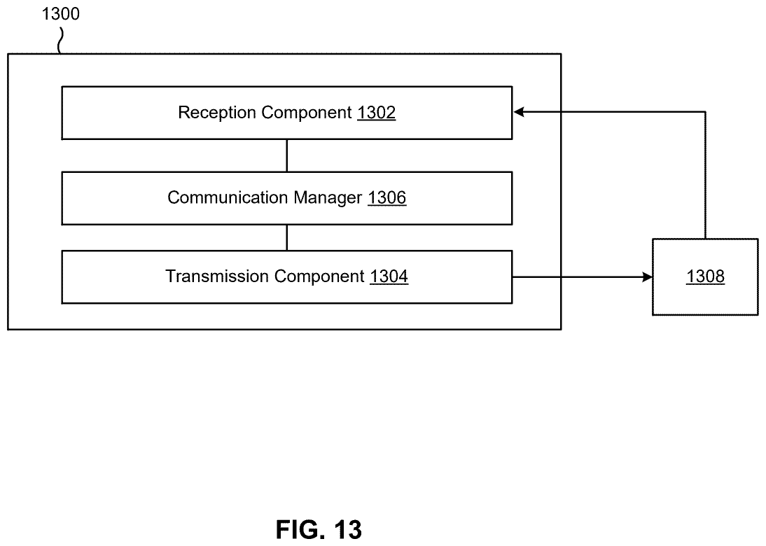

In some aspects, a network entity (e.g., a network node 110) includes means for transmitting, prior to handover or after handover but before reception of a CSI report, cell parameters for both HD and FD symbol types for use in one or more candidate cells to a UE; or means for receiving the CSI report for each of the HD and FD symbol types based at least in part on the cell parameters. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

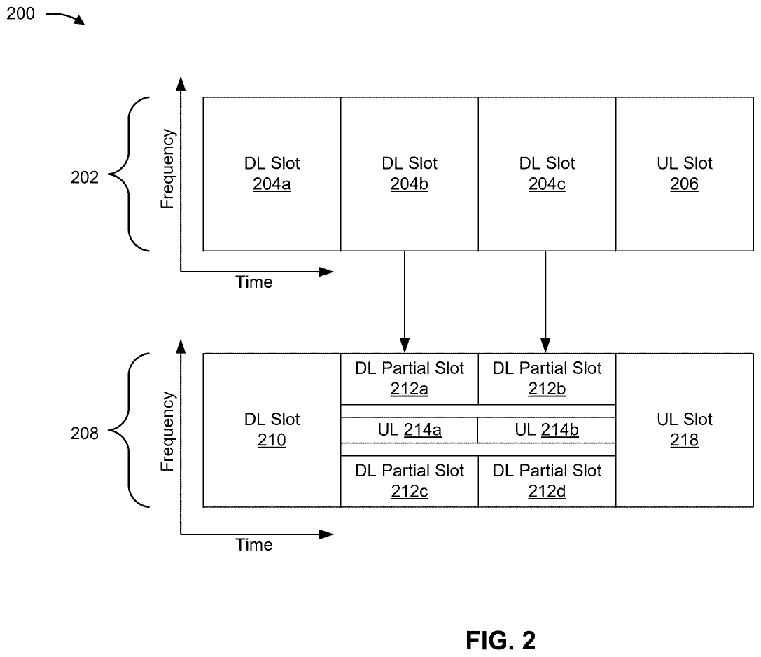

FIG. 2 is a diagram illustrating an example 200 of SBFD. As shown in FIG. 2, example 200 includes a first configuration 202. In some aspects, the first configuration 202 may indicate a first slot format pattern (sometimes called a TDD pattern) associated with an HD symbol type. The first slot format pattern may include a quantity of downlink slots (e.g., three downlink slots 204a, 204b, and 204c, as shown), a quantity of flexible slots (not shown), or a quantity of uplink slots (e.g., one uplink slot 206, as shown). The first slot format pattern may repeat over time. In some aspects, a network entity (e.g., network node 110) may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as RRC message, a medium access control (MAC) control element (CE) (MAC-CE), or downlink control information (DCI)) a UE 120 to switch from the first configuration 202 to a second configuration 208. As an alternative, the UE 120 may indicate to the network node 110 that the UE 120 is switching from the first configuration 202 to the second configuration 208. The second configuration 208 may indicate a second slot format pattern that repeats over time, similar to the first slot format pattern. In any of the aspects described above, the UE 120 may switch from the first configuration 202 to the second configuration 208 during a time period (e.g., a quantity of symbols or an amount of time (e.g., in ms)) based at least in part on an indication received from the network node 110 (e.g., before switching back to the first configuration 202). During that time period, the UE 120 may communicate using the second slot format pattern, and then may revert to using the first slot format pattern after the end of the time period. The time period may be indicated by the network node 110 (e.g., in the instruction to switch from the first configuration 202 to the second configuration 208, as described above) or based at least in part on a programmed or otherwise preconfigured rule. For example, the rule may be based at least in part on a table (e.g., defined in 3GPP specifications or another wireless communication standard) that associates different sub-carrier spacings (SCSs) or numerologies (e.g., represented by μ and associated with corresponding SCSs) with corresponding time periods for switching configurations.

In example 200, the second slot format pattern is an FD symbol type that includes two SBFD slots in place of what were downlink slots in the first slot format pattern. In example 200, each SBFD slot includes a partial slot (e.g., a portion or sub-band of a frequency allocated for use by the network node 110 and the UE 120) for downlink (e.g., partial slots 212a, 212b, 212c, and 212d, as shown) and a partial slot for uplink (e.g., partial slots 214a and 214b, as shown). Accordingly, the UE 120 may operate using the second slot format pattern to transmit an uplink communication in an earlier slot (e.g., the second slot in sequence, shown as partial UL slot 214a) as compared to using the first slot format pattern (e.g., the fourth slot in sequence, shown as UL slot 206). Other examples may include additional or alternative changes. For example, the second configuration 208 may indicate an SBFD slot in place of what was an uplink slot in the first configuration 202 (e.g., UL slot 206). In another example, the second configuration 208 may indicate a downlink slot or an uplink slot in place of what was an SBFD slot in the first configuration 202 (not shown in FIG. 2). In yet another example, the second configuration 208 may indicate a downlink slot or an uplink slot in place of what was an uplink slot or a downlink slot, respectively, in the first configuration 202. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 2). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an FD mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 202 to the second configuration 208, the network node 110 and the UE 120 may experience increased quality or reliability of communications. For example, the network node 110 and the UE 120 may experience increased throughput (e.g., using a full-duplex mode), reduced latency (e.g., the UE 120 may be able to transmit an uplink or a downlink communication sooner using the second configuration 208 rather than the first configuration 202), and increased network resource utilization (e.g., by using both the DL BWP and the UL BWP simultaneously instead of only the DL BWP or the UL BWP).

When full duplex (FD) is enabled at a cell and/or UE, the operation parameters may differ from those in half duplex (HD). For example, in the case of cell SBFD, a set of consecutive SBFD symbols can be configured within the TDD slot-format pattern, (i.e., TDD-UL-DL-ConfigCommon). The remaining HD symbols can be DL, UL, or flexible symbols for HD operation, such as for non-SBFD UE or critical control/data in case of degraded FD performance.

In SBFD symbols, two separate cell panels are used for DL and UL subbands simultaneously. In HD symbols, a single combined cell panel can be used for DL or UL to fully exploit all antenna elements. Therefore, DL/UL MIMO parameters can be different for FD and HD symbol types, such as rank, PMI, and CQI. Additionally, MIMO parameters can also vary for UE-side FD with UE antenna configuration different from HD.

To account for different antenna configurations and interference, SBFD may use separate CSI-RS resources for CSI feedback for HD and FD symbol types, respectively. In SBFD symbols, non-consecutive CSI-RS in frequency is introduced, enabling the UE to compute CSI parameters per sub-subband within each DL subband, as different sub-subbands may experience varying levels of leaked interference from the UL subband.

Besides CSI parameters, SBFD can have separate SRS resources for UL sounding, RACH resources, UL power control parameters for a given UL beam, and PUCCH frequency hopping patterns. These are different from those a HD symbol type to account for different cell UL antenna configurations, more consecutive UL resources, additional cell self-interference to UL, and smaller UL bandwidth, respectively. Other parameters are under discussion or have been discussed, such as beam and TA.

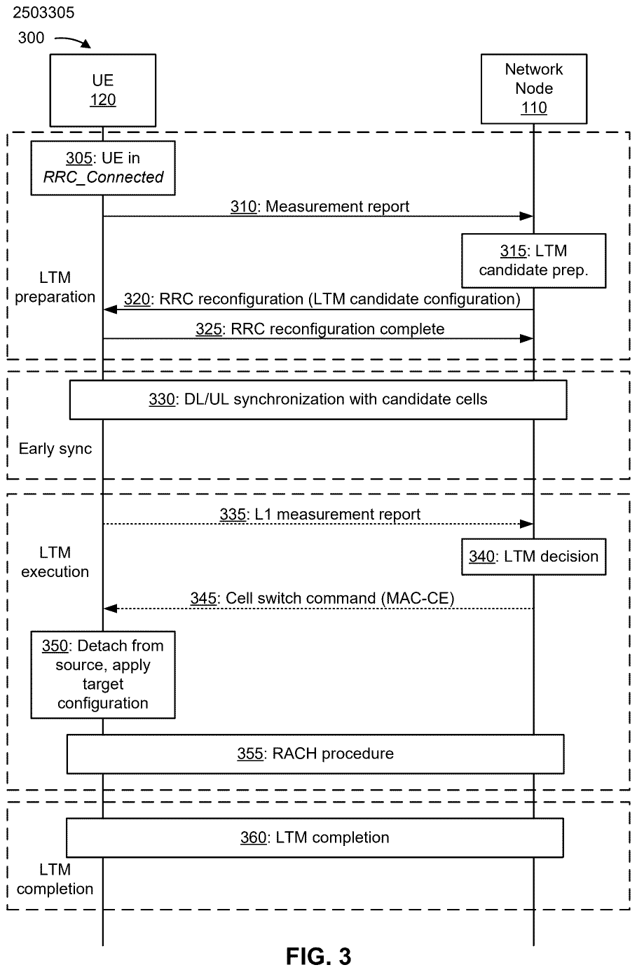

FIG. 3 is a diagram illustrating an example 300 of a Layer 1/Layer 2 (L1/L2) triggered mobility (LTM) procedure.

In some examples, a network entity (e.g., network node 110) may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a Layer 3 (L3) handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages or other L3 signaling and operations used to perform the handover procedures. Accordingly, in some examples, a UE 120 may be configured to perform a lower-layer (e.g., L1 or L2) handover procedure, sometimes referred to an LTM procedure, such as the example 300 LTM procedure shown in FIG. 3. As shown in FIG. 3, the LTM procedure may include four phases: an LTM preparation phase, an early synchronization phase (shown as “early sync” in FIG. 3), an LTM execution phase, or an LTM completion phase.

During the LTM preparation phase, and as shown by reference number 305, the UE 120 may be in an RRC connected state (sometimes referred to as RRC_Connected) with a source cell. As shown by reference number 310, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, or CQI) or similar measurements associated with the source cell or one or more neighboring cells. In some examples, based at least in part on the measurement report or other information, the network node 110 may decide to use LTM, and thus, as shown by reference number 315, the network node 110 may initiate LTM candidate preparation.

As shown by reference number 320, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE or cells for which the UE 120 may later be triggered to perform an LTM procedure. As shown by reference number 325, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 330, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with reference number 335). In some aspects, performing the early synchronization with the one or more candidate cells may reduce latency associated with performing a random access channel (RACH) procedure later in the LTM procedure, which is described in more detail below in connection with reference number 355.

During the LTM execution phase, and as shown by reference number 335, the UE 120 may perform L1 measurements on the configured LTM candidate target cells, and thus may transmit, to the network node 110, lower-layer (e.g., L1) measurement reports. As shown by reference number 340, based at least in part on the lower-layer measurement reports, the network node 110 may decide to execute an LTM cell switch to a target cell. Accordingly, as shown by reference number 345, the network node 110 may transmit, and the UE 120 may receive, a MAC-CE or similar message triggering an LTM cell switch (the MAC-CE or similar message is sometimes referred to herein as a cell switch command). The cell switch command may include an indication of a candidate configuration index associated with the target cell. As shown by reference number 350, based at least in part on receiving the cell switch command, the UE 120 may switch to the configuration of the LTM candidate target cell (e.g., the UE 120 may detach from the source cell and apply the target cell configuration). Moreover, as shown by reference number 355, the UE 120 may perform a RACH procedure towards the target cell, such as when a timing advance associated with the target cell is not available (e.g., in examples in which the UE 120 did not perform the early synchronization as described above in connection with reference number 330).

During the LTM completion phase, and as shown by reference number 360, the UE 120 may indicate successful completion of the LTM cell switch towards the target cell. In this way, cell switch to a target cell may be performed using less overhead than for an L3 handover procedure or a cell switch to a target cell may be associated with reduced latency as compared to L3 handover procedure.

In 5G LTM, various early candidate cell preparation schemes have been considered to improve throughput after a particular candidate cell is selected as the target cell. The candidate cell generally refers to the candidate primary cell (PCell), whose carrier aggregation (CA) configuration is also provided to the UE in advance.

In 3GPP Release 18, before handover, for a promising candidate cell, the UE can determine the best receive (Rx) beam for a good SSB based on its L1-RSRP measurement, activate the corresponding TCI state, and determine the corresponding timing advance (TA) based on physical random access channel (PRACH) transmission to the candidate cell. In Release 19, before handover, for a promising candidate cell, the UE can perform beam refinement with CSI-RS based L1-RSRP measurement, activate the corresponding TCI state, and determine the corresponding CSI parameters for DL MIMO operation.

In 5G LTM, various early preparations are primarily designed for a single duplex mode at the candidate cell, either TDD or FDD. There are no early preparations for multiple duplex modes, such as TDD and SBFD. Consequently, after handover to an SBFD-capable candidate cell, the UE may not be able to operate in both HD and SBFD symbol types. This limitation may affect throughput, latency, and coverage.

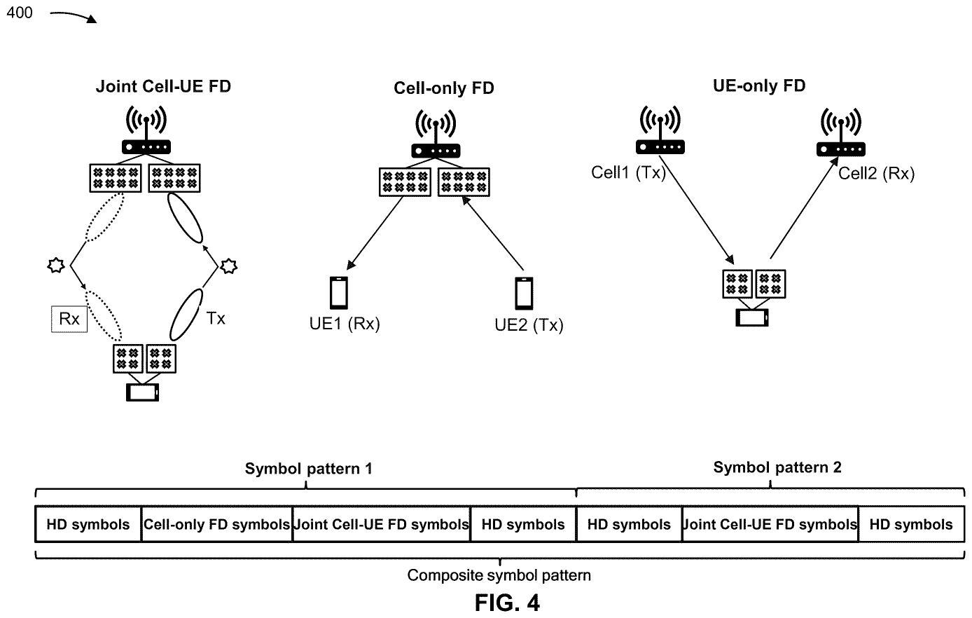

FIG. 4 is a diagram illustrating an example 400 of symbol patterns.

According to various aspects described herein, to support immediate FD operation after handover, early preparations (e.g., before handover or after handover but before CSI feedback transmission) for the candidate cell may consider multiple duplex modes, including at least an FD symbol type, which can have different variants. A network entity may provide (and a UE may receive) TDD slot-format configurations per candidate cell, including both HD and FD symbol types, as well as DL/UL sub-band configurations for FD symbols.

The network entity may further provide (and the UE may receive) separate resources for HD and FD early preparations, such as CSI-RS, SRS, RACH, and CLI resources, to determine separate DL/UL precoders, MCS, beams, TA, and TRP(s)/SCell(s)/SCG to be activated. The network entity may signal separate operation parameters to be used for HD and FD operations after handover, including the parameters determined in early preparations.

In some aspects, the network entity may indicate whether to use HD or FD DL/UL resources for handover. For an FD-capable UE, the network entity may verify whether joint cell-UE FD is feasible for a promising candidate cell and, if feasible, provide the corresponding operation parameters and DL/UL resources to be used after handover.

For each candidate cell, a network entity may provide a time-domain symbol pattern indication for different HD and FD symbol types. The candidate cell can be used for any type of handover, such as L3 HO, CHO, LTM, or C-LTM. One use case of the symbol pattern is to identify resource occasions associated with each symbol type. For example, for periodic CSI-RS resources configured to measure CSI in a particular FD symbol type, the UE may measure only occasions fully contained within the corresponding FD symbols.

HD symbol types include DL, UL, and flexible symbols. FD symbol types include cell-only, UE-only, and/or joint cell-UE FD symbol types, shown in example 400. A symbol type may follow a pattern. The time-domain symbol pattern can be periodic, and multiple patterns can be configured and used jointly. For instance, individual patterns can sequentially form a composite periodic pattern. Example 400 shows symbol patterns (e.g., symbol pattern 1, symbol pattern 2) for different HD and FD symbol types. In each individual symbol pattern, the symbol locations of a particular symbol type can be indicated by the following parameters: the starting and ending slot indices, the starting symbol index within the starting slot, and the ending symbol index within the ending slot.

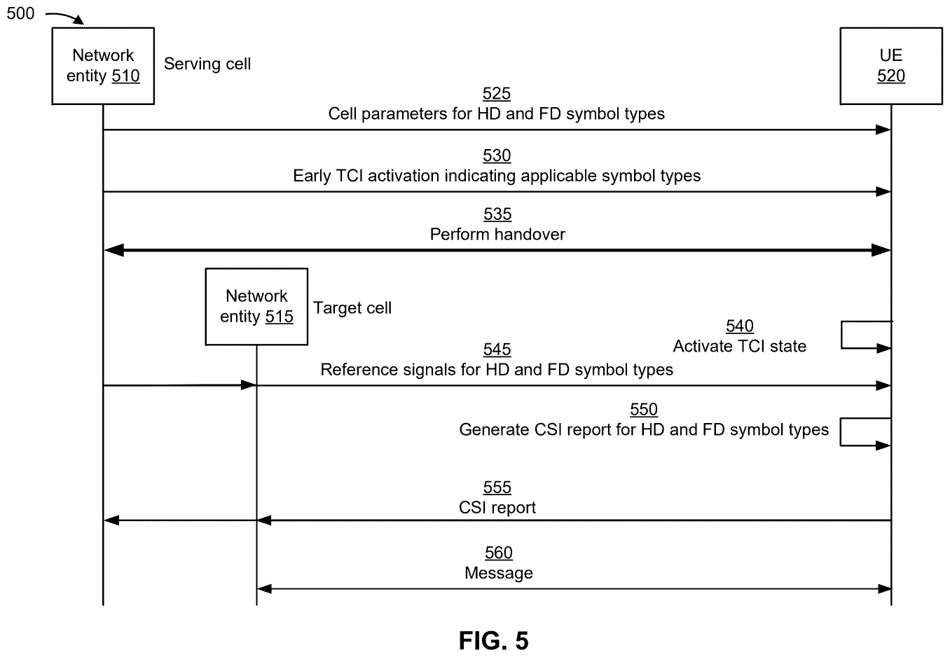

FIG. 5 is a diagram illustrating an example 500 associated with early preparation for handover for HD and FD symbol types. As shown in FIG. 5, a network entity 510 (e.g., network node 110) and a UE 520 (e.g., UE 120) may communicate with one another. Network entity 510 may provide a serving cell. Network entity 515 (e.g., network node 110) may provide a target cell, which is one of multiple candidate cells.

As shown by FIG. 5, and reference number 525, a network entity 510 may provide cell parameters for HD and FD symbol types to a UE 520. For example, the network entity 510 may transmit the cell parameters, which include a TDD slot format configuration, downlink and uplink frequency resources, and operation parameters for HD and FD symbol types for one or more candidate cells. The cell parameters may also include an uplink synchronization configuration and measurement resources for each candidate cell separately for HD and FD symbol types.

In some aspects, the cell parameters may include cross-link interference (CLI) measurement configuration parameters for each symbol type. For example, the network entity 510 may provide these parameters to enable the UE 520 to measure and report CLI for both HD and FD symbol types. This allows for the optimization of the operation of candidate cells by mitigating interference issues.

Additionally, or alternatively, the cell parameters may include sounding reference signal transmission configuration parameters that include a port number, a comb offset, and a frequency hopping pattern for each symbol type. For example, the network entity 510 may provide these detailed parameters to ensure that the UE 520 properly configures and transmits SRSs for both HD and FD symbol types. This enhances the accuracy and reliability of the reference signal transmissions.

Additionally, or alternatively, the cell parameters may include uplink synchronization configuration parameters that include uplink frequency information, uplink bandwidth part information, and PRACH time and frequency locations. For example, the network entity 510 may provide these comprehensive parameters to ensure accurate synchronization of uplink transmissions from the UE 520 to the target cell. This ensures efficient and timely communication.

Additionally, or alternatively, the network entity 510 may configure different MIMO parameters for SBFD and HD operations. For example, for SBFD symbols, two separate cell panels are used for DL and UL sub-bands simultaneously, while for HD symbols, a single combined cell panel can be used for either DL or UL to fully exploit all antenna elements. Consequently, DL/UL MIMO parameters, such as rank, PMI, and CQI, may differ for SBFD and HD operations. This allows for optimized MIMO configuration for different operation modes.

Additionally, or alternatively, the cell parameters provided by the network entity 510 may include detailed DL/UL frequency resources for different HD and FD symbol types for each candidate cell. For example, multiple subbands may be configured per candidate cell, identified by SCS, DL/UL direction, starting/ending RB or tone, and the number of RBs or tones. Usable DL/UL RBs or tones are determined based on the interaction between DL/UL sub-bands and active DL/UL BWPs. This provides flexibility and precise control over frequency resource allocation.

The UE only receives or transmits DL/UL signals within the corresponding usable DL/UL RBs. For certain symbol types, such as the HD symbol type, the sub-band indication may not be needed, and the entire bandwidth (BW) of active DL/UL BWPs is used. Different FD modes can be supported by various combinations of DL/UL frequency resources and symbol types. For example, SBFD can be achieved by configuring non-overlapped DL/UL frequency resources over network-only FD symbol types.

Additionally, or alternatively, the network entity 510 may configure the UE 520 to perform self-interference related measurements to verify the feasibility of FD operation for a candidate cell. For example, this configuration may include the use of different UL Tx and DL Rx antennas, or measuring the transmitted signal as leaked UE self-interference with another set of DL Rx antennas. The transmitted signal for self-interference measurement can be SRS, PRACH, PUCCH, or PUSCH.

The network entity (or a specification) may determine the parameters for the UE's transmitted signal, such as the beam, precoder, and power. The UE's self-interference (SI) related measurement resource can be configured within a dedicated time and/or frequency resource. This ensures accurate assessment of self-interference levels. Alternatively, a priority or dropping rule can be introduced if there is an overlap with DL/UL signals for the serving cell.

For example, for FR1, to measure UE self-interference, the network entity may configure the UE to transmit with a set of uplink (UL) transmit antennas and measure the transmitted signal as leaked UE SI with another set of downlink (DL) receive antennas. Alternatively, the UE may derive the CSI parameters based on CSI-RSs by considering the self-interference.

In another example, for FR2, to measure UE SI, the network entity may configure the UE to transmit with a candidate UL beam from one panel and measure the transmitted signal as leaked UE SI with a candidate DL beam from another panel. Alternatively, the UE may derive the CSI parameters based on CSI-RSs by considering the self-interference.

Additionally, or alternatively, the cell parameters may include advanced beam refinement and CSI feedback configurations before handover. For example, the network entity 510 may provide CSI-RS resources from candidate cells to the UE 520, enabling the UE to refine beams and compute channel state information parameters. This feedback is then provided to the network entity 510 to facilitate downlink MIMO operation soon after handover. This allows the network entity 510 to optimize downlink communication parameters ahead of the handover.

Additionally, or alternatively, the cell parameters may include uplink synchronization configurations for different symbol types. For example, the network entity 510 may instruct the UE 520 to perform uplink synchronization based on specific symbol types, using PRACH transmissions to acquire TA commands for each symbol type. This ensures precise timing and synchronization for uplink transmissions.

The network entity may instruct the UE to select an early UL synchronization resource for a particular symbol type based on the quality of the PRACH reception. For example, the network entity may initially trigger a PDCCH-ordered PRACH to the RACH occasion (RO) in SBFD symbols of the candidate cell. If the PRACH is not received after a certain number of attempts, the network entity may then trigger the PRACH to the RO in HD symbols.

The network entity may provide the following early UL sync-related configuration parameters per symbol type, such as UL frequency information, UL BWP information, RO time and frequency locations, SSB to RACH resource mapping information, SSB configuration, PRACH sequence information, time-domain slot and symbol format, PRACH power control information, PRACH TA information, and PRACH triggering DCI content information. These detailed configurations ensure that the UE can accurately perform early UL synchronization for each symbol type in a candidate cell, optimizing the timing and reliability of uplink transmissions.

An uplink synchronization configuration may include multiple cell parameters for each of the HD symbol type and the FD symbol type. In the context of early UL synchronization configuration parameters, the network entity 510 may provide specific configurations to the UE to ensure accurate and timely uplink synchronization for different symbol types (HD and FD) for each candidate cell. This early preparation minimizes handover disruptions and ensures seamless communication with the target cell.

The early UL synchronization configuration parameters may include UL frequency information that specifies the uplink frequency bands or subbands that the UE should use for uplink transmissions, ensuring that the UE transmits within the correct frequency range. The configuration parameters may include UL BWP information that defines the specific BWPs allocated for uplink transmissions, helping the UE to focus its transmission power and resources within the designated BWPs. The configuration parameters may include RACH time and frequency locations that indicate the time and frequency resources allocated for RACH transmissions, ensuring that the UE can perform random access procedures accurately, which involves initial synchronization and TA acquisition.

The early UL synchronization configuration parameters may include SSB to RACH resource mapping information that provides the mapping between SSBs and corresponding RACH resources, helping the UE to determine the appropriate RACH resources based on the received SSBs. An SSB configuration specifies the configuration of SSBs, including parameters such as periodicity, timing, and frequency, ensuring that the UE can accurately detect and decode SSBs. PRACH sequence information defines the PRACH sequences that the UE is to use for random access transmissions, ensuring that the UE uses the correct sequences for successful random access and TA acquisition.

The early UL synchronization configuration parameters may include a time-domain slot/symbol format that specifies the time-domain structure of slots and symbols for uplink transmissions, helping the UE to align its transmission timing with the network. PRACH power control information provides power control parameters for PRACH transmissions, such as power levels and adjustments, ensuring that the UE transmits with appropriate power levels. PRACH TA information indicates the timing advance values that the UE should use for uplink transmissions, ensuring that the UE's transmissions are time-aligned with the network. PRACH triggering DCI content information defines the DCI content used to trigger PRACH transmissions, ensuring that the UE can respond to network triggers accurately.

The RRC parameters related to an early UL synchronization configuration help to signal the necessary configurations to the UE. These parameters are typically included in RRC messages exchanged between the network entity and the UE. Some RRC parameters may include RRCReconfiguration, an RRC message used to reconfigure the UE's radio resource settings, including early UL sync configurations. RRC parameters may include EarlyUL-SyncConfig-r18 as an IE within the RRCReconfiguration message that specifies the early UL synchronization configuration parameters for different symbol types. EarlyUL-SyncConfigSUL-r18 provides early UL synchronization configuration parameters for supplementary uplink (SUL) operations. LTM-Candidate-r18 includes the configuration for candidate cells in long-term mobility (LTM) scenarios, containing early preparation parameters, including early UL sync configuration. LTM-TCI-Info-r18 provides information about the TCI states for candidate cells, including details about the applicable symbol types and corresponding TCI states for early TCI activation. LTM-UE-MeasuredTA-ID-r18 indicates the timing advance ID measured by the UE for candidate cells, helping the network to determine the appropriate TA values for uplink synchronization.

The process begins with the network entity configuring the early UL synchronization parameters for each candidate cell, specifying the necessary details for HD and FD symbol types. These configurations are included in RRCReconfiguration messages and transmitted to the UE. The UE receives the RRCReconfiguration messages, extracts the early UL synchronization parameters, and updates its configuration based on the received parameters, preparing for uplink synchronization. The UE then performs uplink synchronization based on the configured parameters, ensuring accurate timing and frequency alignment with the network. This may involve performing PRACH transmissions, acquiring timing advance commands, and adjusting its transmission power as specified. Finally, the UE uses the early UL synchronization parameters to prepare for handover to candidate cells, measuring and reporting the necessary synchronization metrics to the network.

By providing detailed early UL synchronization configuration parameters and related RRC parameters, the network entity ensures that the UE can achieve accurate and timely uplink synchronization for different symbol types. This early preparation minimizes handover disruptions and ensures seamless communication with the target cell.

In some aspects, the network entity may provide various configuration parameters as cell parameters, for each of the HD symbol type and the FD symbol type, for the UE to determine the early CSI-RS measurement resources per symbol type for a candidate cell. These parameters include the CSI-RS time behavior, which can be periodic, semi-persistent, or aperiodic. For periodic and semi-persistent configurations, the period and time offset from a reference timing, such as system frame number (SFN)=0, are specified. For aperiodic configurations, the time offset from the triggering DCI and the corresponding CSI request codepoint are provided.

X-port CSI-RS configuration may be achieved by a single or multiple CSI-RS resources within a CSI-RS resource set. For example, a 128-port CSI-RS can be configured using a single 128-port CSI-RS resource or by combining four 32-port CSI-RS resources within a CSI-RS resource set. For each CSI-RS resource in the set, the total number of ports, port index assignment, time-frequency dimension per code-division multiplexing (CDM) group, multiplexed port number per CDM group, time-frequency locations per CDM group within the corresponding slot, sequence or scrambling ID, and QCL source RS to determine the UE Rx spatial filter are specified.

Additionally, for the transmitted CSI-RS resource set, parameters such as subcarrier spacing (SCS), resource set type (e.g., CSI acquisition, beam management, antenna switching, TRS), power offset to other signals (e.g., SSB and PDSCH), multiplexing/prioritization rule with other signals, and availability indicator for a given time window, which may be dynamically signaled in broadcast DCI, are provided.

Furthermore, the configuration may include whether additional CSI-RS resource sets are configured for interference measurement. For instance, a zero power (ZP) CSI-RS resource set and/or a non-ZP (NZP) CSI-RS resource set can be additionally configured to measure interference. These comprehensive configuration parameters ensure that the UE can accurately determine and utilize the early CSI-RS measurement resources for each symbol type in a candidate cell.

In some aspects, the network entity (or a specification) may provide, for each of the HD symbol type and the FD symbol type, various configuration parameters as cell parameters for the UE to report the early CSI-RS measurement results per symbol type for a candidate cell.

These parameters include the reported metrics, such as CQI, PMI, rank indicator, layer indicator, L1-RSRP, L1-SINR, time-domain channel correlation, CLI-RSSI, CLI-SRS-RSRP, L3-CLI-RSSI, and L3-CLI-SRS-RSRP. The PMI codebook type, which can be type1 or type2, is also specified.

Restrictions on the reported metrics may be applied, such as a fixed or maximum rank number or considering only a subset of candidate beams in the codebook. The reported bandwidth can be wideband (covering the whole BWP), partial BWP (covering part of the BWP), or sub-bands (covering multiple sections of the BWP).

The reporting resource and format are also defined, which may include PUSCH/PUCCH scheduled by DCI/MAC-CE, long/short PUCCH format, and whether the report is carried in UCI or MAC-CE. The report time behavior can be aperiodic, semi-persistent, or periodic. Additionally, the number of reported resources per metric type is specified.

These comprehensive configuration parameters ensure that the UE can accurately report the early CSI-RS measurement results for each symbol type in a candidate cell, providing the network with detailed and reliable information for optimizing cell operations.

In some aspects, the network entity may transmit a resource configuration for early SRS transmission for each of the HD symbol type and the FD symbol type. The configuration may include various configuration parameters for the UE to determine the early SRS transmission resources per symbol type for a candidate cell. These parameters include the SRS time behavior, which can be aperiodic, semi-persistent, or periodic. The number of SRS resource sets and the number of SRS resources per set are also specified.

For each SRS resource within an SRS resource set, the configuration parameters may include the port number, comb offset, root sequence index, cyclic shift, total number of symbols, symbol repetition factor, symbol locations within the corresponding slot, RB range, frequency hopping pattern across different repetitions, time/frequency location per repetition, QCL source RS to determine the spatial Tx filter, and the time offset from the reference DL/UL signal triggering the SRS in the case of aperiodic or semi-persistent SRS, such as DCI, MAC-CE, or acknowledgement (ACK) for the MAC-CE.

For the SRS resource set, additional parameters may include TA information, subcarrier spacing (SCS), power control parameters such as P0, alpha, closed loop index, and path loss reference signal. The SRS resource set type is also specified, which can include antenna switching, codebook, non-codebook, and beam management.

These comprehensive configuration parameters ensure that the UE can accurately determine and utilize the early SRS transmission resources for each symbol type in a candidate cell, optimizing the performance and reliability of the uplink transmissions.

In some aspects, the network entity (or a specification) may provide, for each of the HD symbol type and the FD symbol type, various configuration parameters as cell parameters for the UE to determine the early CLI measurement resources per symbol type for a candidate cell. These parameters include the CLI measurement and reporting type, which can be L1, L2, or L3, and are reported via UCI, MAC-CE, or RRC, respectively. For L3 measurements, the corresponding time filter coefficient is also specified.

The CLI resource time behavior can be periodic, semi-persistent, or aperiodic. For periodic and semi-persistent configurations, the period and time offset from a reference timing, such as SFN=0, are specified. For aperiodic configurations, the time offset from the triggering DCI and the corresponding CSI request codepoint are provided.

For each CLI resource in the CLI resource set, different parameters are specified based on the type of CLI resource. In the case of an SRS-based CLI resource, the configuration may reuse all or a subset of the parameters listed for early SRS transmission, with the goal being for the UE to measure the SRS-based CLI resource instead of transmitting. In the case of a CLI-RSSI based CLI resource, the parameters include SCS, starting RB index, number of RBs, starting symbol or slot index, number of symbols or slots, and quasi-co-location (QCL) source RS to determine the UE Rx spatial filter. The measurement timing is based on DL or UL timing.

These comprehensive configuration parameters ensure that the UE can accurately determine and utilize the early CLI measurement resources for each symbol type in a candidate cell, optimizing the performance and reliability of the CLI measurements.

In some aspects, for each candidate cell, the network entity may provide early DL and UL measurement resources and reporting configurations separately for different HD and FD symbol types. This is performed to determine in advance the corresponding DL/UL operation parameters, such as precoder, rank, beam, and MCS, which can vary for different duplex modes due to different antenna configurations and interference, as described in the background.

The early measurement resources may include CSI-RS, CLI resources, and SRS, and are indicated to be measured or transmitted via occasions corresponding to specific symbol types. For example, for early CSI-RS measurement per symbol type, the UE may only measure resource occasions in HD symbols for periodic CSI-RS indicated for HD measurement, and only measure occasions in DL bands of SBFD symbols for periodic CSI-RSs indicated for SBFD measurement. In the case of a single measurement resource across both DL subbands, only the part within the DL usable RBs is measured.

These configurations ensure that the UE can accurately perform early DL/UL measurements for each symbol type in a candidate cell, allowing the network to optimize the operation parameters and improve overall performance and reliability.

In some aspects, in the case of periodic/semi-persistent (P/SP) resources, the applicable symbol type(s) can be indicated via RRC. For semi-persistent/aperiodic (SP/AP) resources, the applicable symbol type(s) may be indicated via activation MAC-CE or triggering DCI, or may be implicitly determined by the symbol type of the earliest occasion.

Early measurement and reporting configuration parameters per symbol type for each candidate cell may include CSI-RS resource parameters, CSI reporting parameters, SRS resource parameters, and CLI resource parameters. Additional reported metrics may include virtual or actual power headroom (PHR), UL RSRP, Pcmax, and Pmax, with the measurement resource for these metrics also indicated by the network or specification if needed.

Unlike the approach where early DL/UL measurements are performed only for the candidate PCell, the early DL/UL measurement may be performed for each candidate cell in a candidate CA or dual connectivity (DC) configuration. This allows the network to quickly decide which secondary cells (SCell(s)) or secondary cell group (SCG) to activate in DL and/or UL after receiving the DL/UL measurement results. In the case of early measurement, the UE may report results to the current serving cell before the UE receives the cell switch command, or to the target cell after the UE receives the cell switch command, depending on the configuration.

Additionally, or alternatively, the cell parameters may enable the configuration of composite symbol patterns. For example, the configuration may involve multiple individual symbol patterns sequentially forming a composite periodic pattern, which can include HD symbols, cell-only FD symbols, UE-only FD symbols, or joint cell-UE FD symbols. This allows the UE 520 to handle various symbol types more effectively.

As further shown in FIG. 5, and by reference number 530, the network entity 510 may transmit an early TCI activation indicating applicable HD and FD symbol types to the UE 520. This early TCI activation message indicates which symbol types are to be used for the candidate cell, and includes separate operation parameters for HD and FD operations after handover.

In some aspects, the early TCI activation message may include separate operation parameters to be used for HD and FD operations after handover. For example, the network entity 510 may provide these parameters to the UE 520 to ensure that it is prepared for both HD and FD operations post-handover. This allows the UE 520 to seamlessly transition and operate in the new cell environment.

Additionally, or alternatively, the early TCI activation message may indicate a single symbol type for an activated TCI state. For example, the message may specify whether the UE 520 should use HD or FD symbol types exclusively for a particular TCI state. This provides clarity and reduces the complexity of the UE's operations.

Additionally, or alternatively, the early TCI activation message may indicate multiple sets of TCIs for multiple symbol types. For example, the message may include several TCIs with associated HD and FD symbol types, allowing the UE 520 to adapt to varying network conditions and requirements. This flexibility enhances the overall performance and reliability of the network.

Additionally, or alternatively, the early TCI activation message may be received as part of a network-controlled handover, and a cell switch command may indicate a symbol type, corresponding operation parameters, and corresponding resources for initial uplink and downlink messages with a target cell until handover completion. For example, during handover, the message may provide detailed instructions to the UE 520 to ensure a smooth transition and continued communication with the target cell. This ensures uninterrupted service and optimal performance during handovers.

Additionally, or alternatively, based on early FD preparation, the network entity 510 may inform the UE 520 about the duplex mode(s) to use, operation parameters per used mode, and used DL/UL resources for a candidate cell once it is selected as the target cell. For example, the operation parameters may include DL/UL beams, precoders, antenna ports, MCS, frequency subbands, panel IDs, UL TA, maximum transmit power, an SRS resource indicator, or a combination thereof. This ensures that the UE 520 is well-prepared for full duplex operation in the target cell.

The DL/UL resources to be used per mode may include RACH, configured grant (CG), PDCCH, and semi-persistent (SPS) occasions. For example, if joint Cell-UE FD is to be used, the UE may use CG occasions for RACH-less handover or RACH occasions for RACH-based handover in the joint cell-UE FD symbols to transmit the first UL message to the candidate cell after the handover is triggered. Additionally, the UE may use PDCCH occasions in the joint cell-UE FD symbols to monitor the DL response from the candidate cell. The duplex mode, operation parameters, and DL/UL resources to be used may be indicated in the cell switch command upon handover being triggered for network-initiated handover, or before the handover is triggered for both network-initiated and UE-initiated handovers.

Additionally, or alternatively, the network entity 510 may provide early measurement and reporting configurations for different HD and FD symbol types. For example, these configurations may include parameters for CSI-RS, CLI resource, and SRS, indicated to be measured or transmitted via resource occasions within the corresponding symbol types. Additional reported metrics may include virtual or actual PHR, UL RSRP, Pcmax, and Pmax. This enables comprehensive measurement and reporting for optimal cell operation.

Next, as shown by reference number 535, the network entity 510 may perform a handover. During this handover process, the UE 520 transitions from a current serving cell to a target candidate cell, utilizing the previously received cell parameters and early TCI activation message to prepare for communication with the target cell.

As further shown by reference number 540, the UE 520 may activate the TCI state. The activation of the TCI state involves the UE 520 initiating the use of the indicated symbol types and corresponding operation parameters for the target cell, as indicated in the early TCI activation message.

In addition, as shown by reference number 545, the UE 520 (or UE 515) may utilize reference signals for HD and FD symbol types. These reference signals are used for measurement and reporting purposes, enabling the UE 520 to assess the CSI for each symbol type.

In some aspects, the UE 520 may receive a configuration for self-interference related measurements to verify feasibility of FD operation for a candidate cell. For example, the network entity 510 may provide this configuration before handover, allowing the UE 520 to conduct tests to ensure that full-duplex operation is viable in the target cell. This helps avoid potential issues with self-interference that could degrade performance.

Additionally, or alternatively, the UE 520 may autonomously perform self-interference related measurements and transmit an indication of a preferred duplex mode and corresponding operation parameters. For example, the UE 520 may conduct these measurements using the provided configuration and then communicate the preferred duplex mode back to the network entity 510. This provides the network with valuable feedback to optimize cell operations.

Additionally, or alternatively, the UE 520 may autonomously perform early FD preparation and self-interference measurements based on a simple indication from the network. For example, the network entity 510 may provide an indication for the UE 520 to begin preparations, and the UE 520 may perform the necessary measurements and then provide feedback on the preferred duplex mode and corresponding parameters. This enables the UE to be proactively prepared for FD operation.

As further shown by reference number 550, the UE 520 may generate a CSI report for HD and FD symbol types based on the reference signals and the cell parameters. The CSI report includes CQIs, PMIs, and RIs for each symbol type.

Finally, as shown by reference number 555, the UE 520 may transmit the CSI report to the network entity 510 (or to network entity 515). This report allows the network entity 510 to optimize communication parameters for both HD and FD operations in the target cell. The UE 520 may communicate (transmit or receive) a message on a beam associated with the TCI state corresponding to each symbol type.

At some point after handover to the target cell of network entity 515, and before the reception of any additional cell parameters (e.g., operational parameters), the UE 520 may communicate a message with the target cell using the early cell parameters. This reduces latency and conserves signaling resources and the UE 520 does not need to wait for cell parameters, such as operation parameters. The UE 520 may receive a switch command without additional cell parameters. The UE 520 may switch to HD symbols or FD symbols without waiting for cell parameters for the D r FD symbols. The cell parameters were received early, before HO or after HO and before transmission of a CSI report.

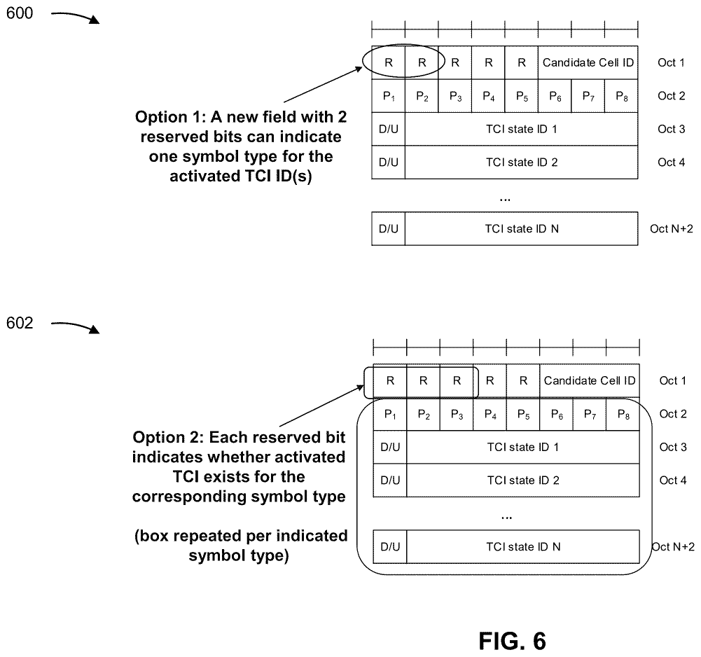

FIG. 6 is a diagram illustrating examples 600 and 602 of early TCI activation for symbol types.

In some aspects for early TCI activation, the corresponding MAC-CE or DCI can be extended to indicate the applicable symbol type, as the DL/UL beams can differ for HD and FD operations. One option, shown by example 600, is for the TCI activation MAC-CE or DCI to indicate only a single symbol type for the activated TCI(s). For example, a new field can be added to specify the applicable symbol type, such as HD, cell-only FD, or joint cell-UE FD symbol type. Example 600 shows that a new field with 2 reserved bits can indicate one symbol type for the activated TCI ID(s). This ensures that the appropriate beams are used for the different duplex modes, optimizing the performance and reliability of the communication.

Another option, shown by example 602, includes the TCI activation MAC-CE or DCI activating multiple sets of TCI(s) for multiple symbol types, respectively. For example, three reserved bits can be used to indicate that TCIs are activated for any set of the three symbol types. Each reserved bit indicates whether activated TCI exists for the corresponding symbol type. The activated TCI IDs can then be concatenated for the indicated symbol types, allowing for flexible and efficient configuration of TCI states across different duplex modes. The box in example 700 is repeated for each symbol type.

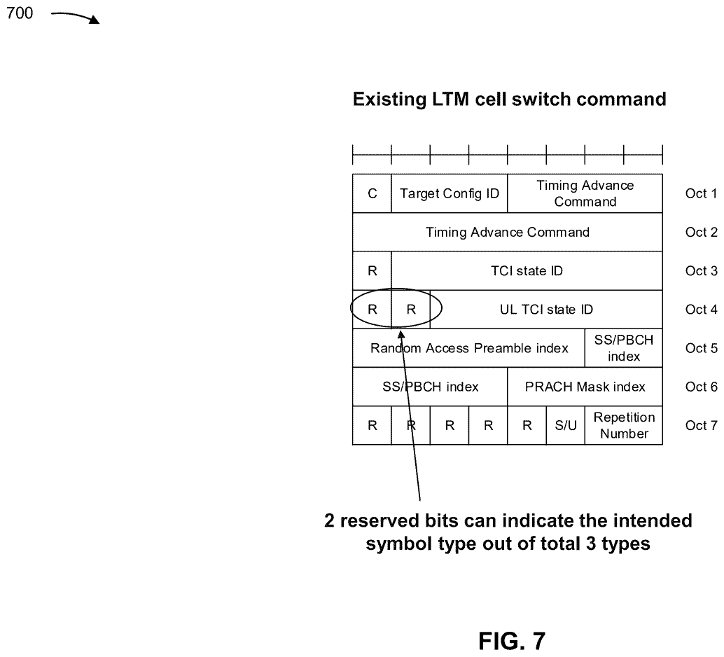

FIG. 7 is a diagram illustrating an example 700 of a cell switch command for symbol types.

In a network-controlled handover, a cell switch command (CSC) may indicate the symbol type, corresponding operation parameters, and resources for the initial UL/DL messages with the target cell, at least until handover completion. For example, two reserved bits in the CSC may specify whether to use the UL resource and/or search space in HD, cell-only FD, or joint cell-UE FD symbols for the first UL or DL message and the corresponding response. Example 700 shows that 2 reserved bits can indicate the intended symbol type out of a total of 3 types. The UL resource may be a configured grant (CG) resource for RACH-less handover or a RACH resource for RACH-based handover, with the corresponding parameters specified in the CSC for the indicated symbol type. These parameters may include the SSB ID, preamble ID, mask ID, and repetition number.

The operation parameters may also include TA and the indicated TCI(s) for DL/UL beams. At least some operation parameters can be indicated for multiple symbol types in the CSC, such as for all HD, cell-only FD, or joint cell-UE FD symbol types, and may be indicated in separate signaling before the CSC. This approach ensures that the UE is properly configured for communication with the target cell during and after the handover process.

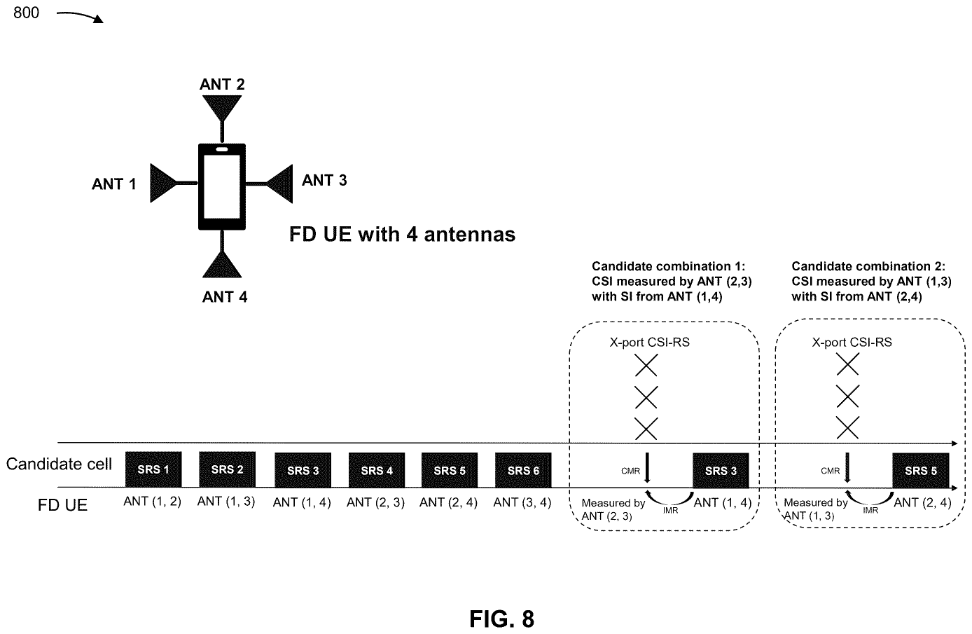

FIG. 8 is a diagram illustrating an example 800 of preparing an FD UE. The FD UE may be prepared in the context of configuring UE SI related measurements and FD operations. Example 800 shows an FR1 UE with four antennas that support FD operation with two transmit (Tx) and two receive (Rx) antennas. The following procedure is used to identify the best Tx and Rx antenna combination for a candidate cell.
Step 1: The serving cell (e.g., network entity 510) instructs the UE (e.g., UE 520) to transmit six codebook-based 2-port SRS resources to the candidate cell, corresponding to all six possible UE 2-Tx antenna combinations. This step involves the UE transmitting SRS resources using different combinations of its transmit antennas to allow the candidate cell to evaluate the uplink performance for each combination.
Step 2: The candidate cell informs the serving cell that SRS resource 3 using Tx antennas (1,4) and SRS resource 5 using Tx antennas (2,4) have good UL performance and provides the corresponding transmitted precoding matrix indicators (TPMIs). This step involves the candidate cell measuring the received SRS resources and identifying which antenna combinations provide the best uplink performance. The candidate cell then communicates this information back to the serving cell.
Step 3: The serving cell instructs the UE to transmit SRS resources 3 and 5 with the identified TPMIs and measure the corresponding self-interferences (SIs) using the other two Rx antennas (2,3) and (1,3), respectively. The UE further measures the CSI by incorporating the corresponding SI as an interference measurement resource (IMR). This step involves the UE using the identified transmit antenna combinations to transmit SRS resources while simultaneously measuring the self-interference on its receive antennas. The UE then calculates the CSI by considering the self-interference as part of the interference measurement.
Step 4: The candidate cell informs the serving cell of the best UE FD antenna combination based on the CSI report and UL measurement for each candidate combination. This final step involves the candidate cell evaluating the CSI reports and uplink measurements from the UE to determine the best combination of transmit and receive antennas for FD operation. The candidate cell then communicates this optimal antenna configuration back to the serving cell.

This procedure ensures that the UE can effectively operate in FD mode by identifying the optimal antenna configurations for both transmission and reception, thereby minimizing self-interference and maximizing uplink performance.

FIG. 9 is a diagram illustrating an example process 900 performed, for example, at a UE or an apparatus of a UE. Example process 900 is an example where the apparatus or the UE (e.g., UE 520) performs operations associated with early FD preparation for handover.

As shown in FIG. 9, in some aspects, process 900 may include receiving, prior to handover or after handover but before transmission of a CSI report, cell parameters for both HD and FD symbol types for use in one or more candidate cells (block 910). For example, the UE (e.g., using reception component 1202 or communication manager 1206, depicted in FIG. 12) may receive, prior to handover or after handover but before transmission of a CSI report, cell parameters for both HD and FD symbol types for use in one or more candidate cells, as described in connection with reference number 525 in FIG. 5.

As further shown in FIG. 9, in some aspects, process 900 may include transmitting the CSI report for each of the HD and FD symbol types based on the cell parameters (block 920). For example, the UE (e.g., using transmission component 1204 or communication manager 1206, depicted in FIG. 12) may transmit the CSI report for each of the HD and FD symbol types based on the cell parameters, as described above in connection with reference number 555 in FIG. 5.

Process 900 may include additional aspects, such as any single aspect or any combination of aspects described below or in connection with one or more other processes described elsewhere herein.

In a first aspect, the cell parameters indicate a time division duplex slot format configuration for a target cell of the one or more candidate cells, indicating the HD and FD symbol types, as shown by example 200 in FIG. 2 and example 400 in FIG. 4.

In a second aspect, alone or in combination with the first aspect, the cell parameters indicate downlink and uplink frequency resources for different HD and FD symbol types.

In a third aspect, alone or in combination with one or more of the first and second aspects, the cell parameters include an uplink synchronization configuration for each candidate cell separately for the HD and FD symbol types.

In a fourth aspect, alone or in combination with one or more of the first through third aspects, the cell parameters indicate measurement resources and a reporting configuration for each candidate cell separately for the HD and FD symbol types.

In a fifth aspect, alone or in combination with one or more of the first through fourth aspects, process 900 includes receiving, before handover, an early TCI activation message for a candidate cell, wherein the early TCI activation message indicates applicable symbol types, as shown by reference number 530 of FIG. 5, FIG. 6, and FIG. 7.

In a sixth aspect, alone or in combination with one or more of the first through fifth aspects, the early TCI activation message includes separate operation parameters to be used for HD and FD operations after handover, as shown by reference number 530 of FIG. 5, FIG. 6, and FIG. 7.

In a seventh aspect, alone or in combination with one or more of the first through sixth aspects, process 900 includes receiving, prior to handover, a configuration for self-interference related measurements to verify feasibility of FD operation for a candidate cell.

In an eighth aspect, alone or in combination with one or more of the first through seventh aspects, the cell parameters include operation parameters per duplex mode, and downlink and uplink resources per duplex mode for a candidate cell selected as a target cell.

In a ninth aspect, alone or in combination with one or more of the first through eighth aspects, process 900 includes autonomously performing self-interference related measurements, and transmitting an indication of a preferred duplex mode and corresponding operation parameters.

In a tenth aspect, alone or in combination with one or more of the first through ninth aspects, the cell parameters include uplink synchronization configuration parameters that include uplink frequency information, uplink bandwidth part information, and physical random access channel time and frequency locations.

In an eleventh aspect, alone or in combination with one or more of the first through tenth aspects, the CSI report includes a channel quality indicator, a precoding matrix indicator, and a rank indicator for each symbol type, as described in connection with FIG. 3 and reference number 555 in FIG. 5.

In a twelfth aspect, alone or in combination with one or more of the first through eleventh aspects, the cell parameters include SRS transmission configuration parameters that include a port number, a comb offset, and a frequency hopping pattern for each symbol type.

In a thirteenth aspect, alone or in combination with one or more of the first through twelfth aspects, the cell parameters include CLI measurement configuration parameters for each symbol type for a candidate cell.

In a fourteenth aspect, alone or in combination with one or more of the first through thirteenth aspects, process 900 includes communicating a message, with a candidate cell selected as a target cell, in FD symbols using the cell parameters, after handover to the target cell and before receiving additional cell parameters.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE. Example process 1000 is an example where the apparatus or the UE (e.g., UE 520) performs operations associated with early full duplex preparation for handover.

As shown in FIG. 10, in some aspects, process 1000 may include receiving an early TCI activation message for a candidate cell that indicates applicable HD and FD symbol types (block 1010). For example, the UE (e.g., using reception component 1202 or communication manager 1206, depicted in FIG. 12) may receive an early TCI activation message for a candidate cell that indicates applicable HD and FD symbol types, as shown by reference number 530 of FIG. 5 and FIG. 6.

As further shown in FIG. 10, in some aspects, process 1000 may include communicating a message on a beam associated with the early TCI activation message using an applicable symbol type (block 1020). For example, the UE (e.g., using reception component 1202, transmission component 1204, or communication manager 1206, depicted in FIG. 12) may communicate a message on a beam associated with the early TCI activation message using an applicable symbol type, as described in connection with FIG. 6.

Process 1000 may include additional aspects, such as any single aspect or any combination of aspects described below or in connection with one or more other processes described elsewhere herein.

In a first aspect, the early TCI activation message includes separate operation parameters to be used for HD and FD operations after handover.

In a second aspect, alone or in combination with the first aspect, the early TCI activation message indicates a single symbol type for an activated TCI, as described in connection with FIG. 6.

In a third aspect, alone or in combination with one or more of the first and second aspects, the early TCI activation message indicates multiple sets of TCIs for multiple symbol types, as described in connection with FIG. 6.

In a fourth aspect, alone or in combination with one or more of the first through third aspects, the early TCI activation message is received as part of a network-controlled handover, and a cell switch command indicates a symbol type, corresponding operation parameters, and corresponding resources for initial uplink and downlink messages with a target cell until handover completion, as described in connection with FIG. 6 and FIG. 7.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network entity or an apparatus of a network entity. Example process 1100 is an example where the apparatus or the network entity (e.g., network entity 510) performs operations associated with early FD preparation for handover.

As shown in FIG. 11, in some aspects, process 1100 may include transmitting, prior to handover or after handover but before reception of a CSI report, cell parameters for both HD and FD symbol types for use in one or more candidate cells to a UE (block 1110). For example, the network entity (e.g., using transmission component 1304 or communication manager 1306, depicted in FIG. 13) may transmit, prior to handover or after handover but before reception of a CSI report, cell parameters for both HD and FD symbol types for use in one or more candidate cells to a UE, as described above.

As further shown in FIG. 11, in some aspects, process 1100 may include receiving the CSI report for each of the HD and FD symbol types based at least in part on the cell parameters (block 1120). For example, the network entity (e.g., using reception component 1302 or communication manager 1306, depicted in FIG. 13) may receive the CSI report for each of the HD and FD symbol types based at least in part on the cell parameters, as described above in connection with FIGS. 5, 6, and 7.

Process 1100 may include additional aspects, such as any single aspect or any combination of aspects described below or in connection with one or more other processes described elsewhere herein.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 1-8. Additionally, or alternatively, the apparatus 1200 may be configured to perform one or more processes described herein, such as process 900 of FIG. 9, process 1000 of FIG. 10, or a combination thereof. In some aspects, the apparatus 1200 or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

In some aspects, the reception component 1202 may receive, prior to handover or after handover but before transmission of a CSI report, cell parameters for both HD and FD symbol types for use in one or more candidate cells. The transmission component 1204 may transmit the CSI report for each of the HD and FD symbol types based on the cell parameters.

The reception component 1202 may receive, before handover, an early TCI activation message for a candidate cell, wherein the early TCI activation message indicates applicable symbol types.

The reception component 1202 may receive, prior to handover, a configuration for self-interference related measurements to verify feasibility of FD operation for a candidate cell. The communication manager 1206 may autonomously perform self-interference related measurements. The transmission component 1204 may transmit an indication of a preferred duplex mode and corresponding operation parameters.

In some aspects, the reception component 1202 may receive an early TCI activation message for a candidate cell that indicates applicable HD and FD symbol types. The reception component 1202 or the transmission component 1204 may communicate a message on a beam associated with the early TCI activation message using an applicable symbol type.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network entity.

In some aspects, the apparatus 1300 may be configured to perform one or more operations described herein in connection with FIGS. 1-8. Additionally, or alternatively, the apparatus 1300 may be configured to perform one or more processes described herein, such as process 1100 of FIG. 11. In some aspects, the apparatus 1300 or one or more components shown in FIG. 13 may include one or more components of the network entity described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network entity described above in connection with FIG. 1, such as a radio, one or more RF chains, one or more transceivers, or one or more modems, each of which may in turn be coupled with one or more antennas of the network entity.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The transmission component 1304 may transmit, prior to handover or after handover but before reception of a CSI report, cell parameters for both HD and FD symbol types for use in one or more candidate cells to a UE. The reception component 1302 may receive the CSI report for each of the HD and FD symbol types based at least in part on the cell parameters.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving, before transmission of a channel state information (CSI) report, cell parameters for both half-duplex (HD) and full-duplex (FD) symbol types for use in one or more candidate cells; and transmitting the CSI report for each of the HD and FD symbol types based on the cell parameters.
Aspect 2: The method of Aspect 1, wherein the cell parameters indicate a time division duplex slot format configuration for a target cell of the one or more candidate cells, indicating the HD and FD symbol types.
Aspect 3: The method of any of Aspects 1-2, wherein the cell parameters indicate downlink and uplink frequency resources for different HD and FD symbol types.
Aspect 4: The method of any of Aspects 1-3, wherein the cell parameters include an uplink synchronization configuration for each candidate cell separately for the HD and FD symbol types.
Aspect 5: The method of any of Aspects 1-4, wherein the cell parameters indicate measurement resources and a reporting configuration for each candidate cell separately for the HD and FD symbol types.
Aspect 6: The method of any of Aspects 1-5, further comprising: receiving, before handover, an early TCI activation message for a candidate cell, wherein the early TCI activation message indicates applicable symbol types.
Aspect 7: The method of Aspect 6, wherein the early TCI activation message includes separate operation parameters to be used for HD and FD operations after handover.
Aspect 8: The method of any of Aspects 1-7, further comprising: receiving, prior to handover, a configuration for self-interference related measurements to verify feasibility of FD operation for a candidate cell.
Aspect 9: The method of any of Aspects 1-8, wherein the cell parameters include operation parameters per duplex mode, and downlink and uplink resources per duplex mode for a candidate cell selected as a target cell.
Aspect 10: The method of any of Aspects 1-9, further comprising: autonomously performing self-interference related measurements; and transmitting an indication of a preferred duplex mode and corresponding operation parameters.
Aspect 11: The method of any of Aspects 1-10, wherein the cell parameters include uplink synchronization configuration parameters that include uplink frequency information, uplink bandwidth part information, and physical random access channel time and frequency locations.
Aspect 12: The method of any of Aspects 1-11, wherein the CSI report includes a channel quality indicator, a precoding matrix indicator, and a rank indicator for each symbol type.
Aspect 13: The method of any of Aspects 1-12, wherein the cell parameters include sounding reference signal transmission configuration parameters that include a port number, a comb offset, and a frequency hopping pattern for each symbol type.
Aspect 14: The method of any of Aspects 1-13, wherein the cell parameters include cross-link interference measurement configuration parameters for each symbol type for a candidate cell.
Aspect 15: The method of any of Aspects 1-14, further comprising communicating a message, with a candidate cell selected as a target cell, in FD symbols using the cell parameters, after handover to the target cell and before receiving additional cell parameters.
Aspect 16: A method of wireless communication performed by a user equipment (UE), comprising: receiving an early transmission configuration indicator (TCI) activation message for a candidate cell that indicates applicable half-duplex (HD) and full-duplex (FD) symbol types; and communicating a message on a beam associated with the early TCI activation message using an applicable symbol type.
Aspect 17: The method of Aspect 16, wherein the early TCI activation message includes separate operation parameters to be used for HD and FD operations after handover.
Aspect 18: The method of any of Aspects 16-17, wherein the early TCI activation message indicates a single symbol type for an activated TCI.
Aspect 19: The method of any of Aspects 16-18, wherein the early TCI activation message indicates multiple sets of TCIs for multiple symbol types.
Aspect 20: The method of any of Aspects 16-19, wherein the early TCI activation message is received as part of a network-controlled handover, and a cell switch command indicates a symbol type, corresponding operation parameters, and corresponding resources for initial uplink and downlink messages with a target cell until handover completion.
Aspect 21: A method of wireless communication performed by a network entity, comprising: transmitting, prior to handover or after handover but before reception of a channel state information (CSI) report, cell parameters for both half-duplex (HD) and full-duplex (FD) symbol types for use in one or more candidate cells to a user equipment (UE); and receiving the CSI report for each of the HD and FD symbol types based at least in part on the cell parameters.
Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.
Aspect 23: An apparatus for wireless communication at a device, the apparatus comprising one or more memories and one or more processors coupled to the one or more memories, the one or more processors configured to cause the device to perform the method of one or more of Aspects 1-21.
Aspect 24: An apparatus for wireless communication, the apparatus comprising at least one means for performing the method of one or more of Aspects 1-21.
Aspect 25: A non-transitory computer-readable medium storing code for wireless communication, the code comprising instructions executable by one or more processors to perform the method of one or more of Aspects 1-21.
Aspect 26: A non-transitory computer-readable medium storing a set of instructions for wireless communication, the set of instructions comprising one or more instructions that, when executed by one or more processors of a device, cause the device to perform the method of one or more of Aspects 1-21.
Aspect 27: A device for wireless communication, the device comprising a processing system that includes one or more processors and one or more memories coupled with the one or more processors, the processing system configured to cause the device to perform the method of one or more of Aspects 1-21.
Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.
Aspect 29: A device comprising a processing system that includes one or more processors and one or more code-storing memories coupled with the one or more processors, the processing system configured to cause the device to perform the method of one or more of Aspects 1-21.
Aspect 30: A device comprising a processing system that includes processor circuitry and code-storing memory circuitry, the processing system configured to cause the device to perform the method of one or more of Aspects 1-21.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled to the one or more memories, the one or more processors individually or collectively configured to:
receive, before transmission of a channel state information (CSI) report, cell parameters for both half-duplex (HD) and full-duplex (FD) symbol types for use in one or more candidate cells; and
transmit the CSI report for each of the HD and FD symbol types based on the cell parameters.

2. The apparatus of claim 1, wherein the cell parameters indicate a time division duplex slot format configuration for a target cell of the one or more candidate cells, indicating the HD and FD symbol types.

3. The apparatus of claim 1, wherein the cell parameters indicate downlink and uplink frequency resources for different HD and FD symbol types.

4. The apparatus of claim 1, wherein the cell parameters include an uplink synchronization configuration for each candidate cell separately for the HD and FD symbol types.

5. The apparatus of claim 1, wherein the cell parameters indicate measurement resources and a reporting configuration for each candidate cell separately for the HD and FD symbol types.

6. The apparatus of claim 1, wherein the one or more processors are configured to receive, before handover, an early TCI activation message for a candidate cell, wherein the early TCI activation message indicates applicable symbol types.

7. The apparatus of claim 1, wherein the cell parameters include separate operation parameters to be used for HD and FD operations after handover.

8. The apparatus of claim 1, wherein the one or more processors are configured to receive, prior to handover, a configuration for self-interference related measurements to verify feasibility of FD operation for a candidate cell.

9. The apparatus of claim 1, wherein the cell parameters include operation parameters per duplex mode, and downlink and uplink resources per duplex mode for a candidate cell selected as a target cell.

10. The apparatus of claim 1, wherein the one or more processors are configured to:
autonomously perform self-interference related measurements; and
transmit an indication of a preferred duplex mode and corresponding operation parameters.

11. The apparatus of claim 1, wherein the cell parameters include uplink synchronization configuration parameters that include uplink frequency information, uplink bandwidth part information, and physical random access channel time and frequency locations.

12. The apparatus of claim 1, wherein the CSI report includes a channel quality indicator, a precoding matrix indicator, and a rank indicator for each symbol type.

13. The apparatus of claim 1, wherein the cell parameters include sound reference signal transmission configuration parameters that include a port number, a comb offset, and a frequency hopping pattern for each symbol type.

14. The apparatus of claim 1, wherein the cell parameters include cross-link interference measurement configuration parameters for each symbol type for a candidate cell.

15. The apparatus of claim 1, wherein the one or more processors are configured to communicate a message, with a candidate cell selected as a target cell, in FD symbols using the cell parameters, after handover to the target cell and before receiving additional cell parameters.

16. An apparatus for wireless communication at a user equipment (UE), comprising:
one or more memories; and
one or more processors coupled to the one or more memories, the one or more processors individually or collectively configured to:
receive an early transmission configuration indicator (TCI) activation message for a candidate cell that indicates applicable half-duplex (HD) and full-duplex (FD) symbol types; and
communicate a message on a beam associated with the early TCI activation message using an applicable symbol type.

17. The apparatus of claim 16, wherein the early TCI activation message includes separate operation parameters to be used for HD and FD operations after handover.

18. The apparatus of claim 16, wherein the early TCI activation message indicates a multiple sets of TCIs for multiple symbol types.

19. The apparatus of claim 16, wherein the early TCI activation message is received as part of a network-controlled handover, and a cell switch command indicates a symbol type, corresponding operation parameters, and corresponding resources for initial uplink and downlink messages with a target cell until handover completion.

20. An apparatus for wireless communication at a network entity, comprising:
one or more memories; and
one or more processors coupled to the one or more memories, the one or more processors individually or collectively configured to:
transmit, prior to handover or after handover but before reception of a channel state information (CSI) report, cell parameters for both half-duplex (HD) and full-duplex (FD) symbol types for use in one or more candidate cells to a user equipment (UE); and
receive the CSI report for each of the HD and FD symbol types based at least in part on the cell parameters.
